(19) United States
(12) Patent Application Publication
(10) Pub. No.: US 2022/0349820 A1
(43) Pub. Date: Nov. 3, 2022

(54) FIBER-OPTIC SENSING APPARATUS, SYSTEM AND METHOD FOR CHARACTERIZING METAL IONS IN SOLUTION

(71) Applicant: JINAN UNIVERSITY, Guangzhou (GD)

(72) Inventors: Tuan GUO, Guangzhou (CN); Yong YUAN, Guangzhou (CN); Kaiwei LI, Guangzhou (CN); Gaozhi XIAO, Guangzhou (CN)

(73) Assignee: JINAN UNIVERSITY, Guangzhou (CN)

(21) Appl. No.: 17/613,141

(22) PCT Filed: May 25, 2020
(86) PCT No.: PCT/CN2020/092011

§ 371 Date: Nov. 22, 2021

(30) Foreign Application Priority Data
May 24, 2019 (CN) 201910437558.9

(51) Int. Cl. G01N 21/552

(52) U.S. Cl. CPC G01N 21/554; G01N 2201/088

(57) ABSTRACT

A fiber-optic sensing apparatus, system, and method for characterizing at least one metal ion in a solution are provided. The sensing apparatus includes a fiber-optic sensor and a controller. The sensor includes an optical fiber with tilted grating in its core, and includes a conductive and surface plasmon resonance (SPR)-active coating assembly that allows the sensor to also serve as an electrochemical working electrode. The controller is electrically connected with the sensor, configured to provide an adjustable potential such that when the coating assembly is in contact with the solution, redox reactions of each of the at least one metal ion occur on an outer surface thereof, resulting in a detectable change of the surface plasmon waves generated in the fiber-optic sensor. Based on the change thus detected, identities and/or concentration of the at least one metal ion in the solution can be determined with high accuracy and sensitivity.

### CROSS-REFERENCE TO RELATED APPLICATIONS

The present application is a U.S. national stage application of International Patent Application No: PCT/CN2020/092011 filed on May 25, 2020, which claims priority to Chinese Patent Application No. 201910437558.9 filed on May 24, 2019. The disclosure of these two patent applications is hereby incorporated by reference in their entirety.

### TECHNICAL FIELD

This present disclosure relates to the field of a metal ion detection technology, and specifically to an electrochemical plasmonic fiber-optic sensing apparatus, system and method for detecting metal ions in a solution.

### BACKGROUND

With the rapid development of economy, a large number of wastewater is discharged, causing accumulation of potentially toxic metals, such as heavy metals, in the soil and in the underground water, which in turn results in increasingly severe pollution of these metal ions. For example, some metals, such as lead (Pb), mercury (Hg), manganese (Mn), cobalt (Co), nickel (Ni) copper (Cu), zinc (Zn), or Chromium (Cr), etc. are toxic, even in low concentrations, non-biodegradable, universally distributed, and cause significant harm to human and animal health and the environment. For instance, when the ions of these metals are dissolved in water enter the biosphere and are ingested into an organism, they can be highly detrimental to human health. Therefore, the rapid and accurate detection of the ions of these metals has become an important issue.

At present, the monitoring methods for these metal ions in water are mainly spectroscopy (Karami H et al., 2004), chromatography (Yi R et al., 2018) and electrochemical analysis (Shao Y et al., 2010). Among these, spectroscopy and chromatography are cumbersome, time-consuming and the detection systems are expensive. The anodic stripping voltammetry (ASV) for electrochemical analysis is currently the most widely used method (Hwang J H et al., 2019). However, theses electrochemical methods suffer from unsuppressed electrochemical noise and unavoidable environmental interferences which affect the electrode measurement process, thereby strongly limiting their limit of detection (LOD).

### SUMMARY

In view of the disadvantages associated with existing metal ions detection approaches, this present disclosure provides a fiber-optic sensing apparatus, system, and method for the detection of metal ion(s) in a solution, such as in a aqueous solution.

In one aspect, the present disclosure provides a sensing apparatus for selectively characterizing at least one metal ion in a solution, which includes a fiber-optic sensor and a controller. The fiber-optic sensor includes an optical fiber and a coating assembly over an outside of the optical fiber. The coating assembly is electrically conductive and active to surface plasmon resonance (SPR), and the fiber-optic sensor is configured, when in contact with the solution, to generate surface plasmon waves at an interface between the coating assembly and the solution upon a compatible input light shedding into and propagating in the optical fiber. The controller is electrically connected with the coating assembly of the fiber-optic sensor, and is configured to provide an adjustable potential thereto such that when the coating assembly of the fiber-optic sensor is in contact with the solution, redox reactions of each of the at least one metal ion occur on an outer surface of the coating assembly, resulting in a detectable change of the surface plasmon waves generated in the fiber-optic sensor, wherein the change of the surface plasmon waves contains information of the each of the at least one metal ion in the solution.

Herein, in the sensing apparatus, the optical fiber can comprise a core and a cladding surrounding the core, and the core is provided with a tilted grating having an inclination angle of more than approximately 2°, and preferably in a range of approximately 6°-22°.

Optionally, the fiber-optic sensor further includes a mirror having a reflective surface facing to a light incident surface of the optical fiber. The mirror is configured to reflect optical signals generated and transmitted in the optical fiber back towards the light incident surface of the optical fiber.

Herein, the coating assembly can include a base film layer, which is configured to be both electrically conductive and active to surface plasmon resonance (SPR). Herein, the base film layer can optionally a metal film layer comprising at least one of gold (Au), silver (Ag), platinum (Pt), copper (Cu) or aluminum (Al), or optionally can comprise a semiconductor material, a metal oxide material, a two-dimensional (2D) material, or an optical metamaterial. The base film layer can have a thickness in a range of approximately 20-70 nm, and preferably in a range of approximately 30-50 nm.

In the sensing apparatus, the coating assembly can optionally further include a conductive protective film layer over an outer surface of the base film layer, which is configured to protect an integrity of the base film layer. The protective film layer can comprise a diamond film layer or a silicon film layer, or can comprise at least one of indium tin oxide (ITO), zinc peroxide (ZnO2), tin oxide (SnO2), or indium oxide (In₂O₃).

In the sensing apparatus, the coating assembly can optionally further include a transition film layer sandwiched between the optical fiber and the base film layer, which is configured to improve adhesion of the base film layer to the optical fiber. The transition film layer can comprise at least one of titanium (Ti), molybdenum (Mo), or chromium (Cr).

In the sensing apparatus, an outer surface of the coating assembly can optionally modified to have an increased specific surface area. As such, the outer surface of the coating assembly can comprise a plurality of subtractive microstructures and/or a plurality of additive microstructures. If a plurality of subtractive microstructures are included in the modified outer surface, they can include porous microstructures or winkle-like microstructures, or both. If a plurality of additive microstructures are included in the modified outer surface, they can comprise nanoparticle microstructures, nanotube microstructures, or nanofilm microstructures, or any of their combinations.

Examples of the composition of the plurality of additive microstructures can comprise graphite, graphene, carbon nanoparticles, carbon nanotubes, a metal oxide, a two-dimensional material, an optical metamaterial, or any of heir combinations.

In the sensing apparatus, the controller can comprise an electrochemical station, and the fiber-optic sensor serves as a working electrode of the electrochemical station. The electrochemical station can further include a reference electrode and a counter electrode. The metal ions that can be detected by the fiber-optical sensing apparatus includes ions of metals lead (Pb), mercury (Hg), copper (Cu), zinc (Zn), cobalt (Co), ion (Fe), nickel (Ni), arsenic (Ar), chromium (Cr), etc. Preferably, the metal ions include one or both of Pb²⁺ and Cu²⁺.

In another aspect, a sensing system is further provided. In addition to the sensing apparatus as described above, the sensing system also includes a light source apparatus and a signal detection apparatus. The light source apparatus is optically coupled to a first end of, and is configured to provide the input light into, the optical fiber in the fiber-optic sensor of the sensing apparatus. The signal detection apparatus is coupled to the sensing apparatus and is configured to receive signals of the surface plasmon waves therefrom so as to derive the information of the each of the at least one metal ion in the solution.

Herein, the optical fiber in the fiber-optic sensor of the sensing apparatus can comprise a core and a cladding surrounding the core, and the core is provided with a tilted grating.

In the sensing system, the light source apparatus can include a light source, a polarizer, and a polarization controller, which are sequentially along an optical pathway into the optical fiber in the fiber-optic sensor, and are arranged such that the input light emitted from the light source becomes a polarized light having a polarization direction substantially parallel to an inscription direction of the tilted grating in the core of the optical fiber.

According to some embodiments, the light source comprises a broadband source (BBS), and the signal detection apparatus comprises an optical spectrum analyzer (OSA). According to some other embodiments, the light source comprises a tunable laser source (TLS), and the signal detection apparatus comprises an optical detector and an analog-to-digital converter. The optical detector is configured to detect, and to convert into analog electrical signals, the signals of the plasmon waves from the sensing apparatus; and the analog-to-digital converter is configured to convert the analog electrical signals into digital electrical signals.

According to some embodiments, the signal detection apparatus is coupled to the first end of the optical fiber. A second end of the optical fiber opposing to the first end is provided with a mirror having a reflective surface facing to, configured to reflect optical signals generated and transmitted in the optical fiber back towards the first end of the optical fiber. The sensing system further comprises an optical fiber circulator, which is optically arranged between the light source apparatus and the sensing apparatus along an input optical pathway and between the sensing apparatus and the signal detection apparatus along an output optical pathway, and is configured to separate the input optical pathway and the output optical pathway to allow the signal detection apparatus to obtain the signals of the surface plasmon waves from the sensing apparatus without being influenced by the input light.

According to some other embodiments, the signal detection apparatus is coupled to a second end of the optical fiber.

In the sensing system, optionally the signal detection apparatus is further configured to receive signals of other optical waves transmitted in the core of the optical fiber (i.e. core mode optical signals), which can be used for their calibration over noise information in the information of the each of the at least one metal ion in the solution. Herein the noise information can include a temperature or light intensity jitter of the light source apparatus

In the sensing system, a measurement range for a metal ion concentration in the solution can be from approximately 10⁻⁴ M to approximately 10⁻¹⁰ M, and a limit of detection (LOD) for the concentration of a metal ion in the solution can be lower than 10⁻¹⁰ M.

In yet another aspect, a method for selectively characterizing at least one metal ion in a solution using a sensing apparatus as described above is provided. The method includes the following steps:

(1) arranging the coating assembly of the fiber-optic sensor to be in contact with the solution;

(2) providing the input light into the fiber-optic sensor of the sensing apparatus;

(3) recording an amplitude of the surface plasmon waves transmitted from the fiber-optic sensor when providing, by means of the controller, a first potential to the fiber-optic sensor to allow each of the at least one metal ion to be reduced into a solid metal element corresponding thereto onto the outer surface of the coating assembly, until the amplitude increases to a first plateau;

(4) recording an over-time change of the amplitude of the surface plasmon waves comprising a first sequence of sequentially decreasing plateaus when providing, by means of the controller, a second potential changing over time in a direction reverse to the first potential to the fiber-optic sensor to allow the solid metal element corresponding to each of the at least one metal ion to be oxidized to thereby strip from the coating assembly into the solution, until the amplitude decreases to a last of the first sequence of plateaus; and

(5) analyzing the over-time change of the amplitude of the surface plasmon waves between the first plateau and the last of the first sequence of plateaus to thereby characterize the at least one metal ion in the solution.

Optionally, the first potential can be a substantially constant potential, and the second potential can be configured to change at a substantially constant rate over time.

In the method, step (5) can include the following sub-steps:

taking a derivative calculation at each point of a curve corresponding to the over-time change of the amplitude of the surface plasmon waves between the first plateau and the last of the first sequence of plateaus to thereby obtain a derivative-over-time curve; and

determining an identity of each of the at least one metal ion by identifying a characteristic trough on the derivative-over-time curve, wherein the trough corresponds to a locally fastest amplitude change thereon.

In the method, step (5) can include the following sub-steps:

calculating an amplitude change of the surface plasmon waves between each pair of two neighboring plateaus in a second sequence of plateaus sequentially comprising the first plateau and the first sequence of plateaus; and

determining a concentration of each of the at least one metal ion in the solution by plotting the calculated amplitude change corresponding to each pair of two neighboring plateaus in the second sequence of plateaus against a pre-determined standard curve, wherein the pre-determined standard curve is obtained in advance by plotting a set of sample solutions, each with a known yet different concentration of the each of the at least one metal ion.

Herein the standard curve can be a linear curve obtained by plotting an amplitude change of the surface plasmon waves relative to Log M for each sample solution, where M is a concentration of the each of the at least one metal ion in the each sample solution.

Prior to step (5), the method can further include a step of recording signals of other optical waves transmitted in the core of the optical fiber in the fiber-optic sensor, and step (5) can include:

performing calibration to the over-time change of the amplitude of the surface plasmon waves;

analyzing the calibrated over-time change of the amplitude of the surface plasmon waves between the first plateau and the last of the first sequence of plateaus to characterize the at least one metal ion in the solution.

The following are noted throughout the disclosure. The terms “device”, “apparatus”, and alike are considered to be exchangeable. the terms “amplitude”, “intensity”, and alike are considered to be exchangeable where they are used for description of a strength of an optical signal. The term “solution” is considered as a working system where the metal ions can exist in the form of ions. The term “at least one metal ion” is referred to as at least one type of ions of a metal, including ions of different metals (e.g. Pb and Cu), and also including ions with different electron configurations for a same metal (e.g. Fe²⁺ and Fe³⁺).

### BRIEF DESCRIPTION OF THE DRAWINGS

FIGS. 1A-1C respectively illustrate a perspective view, a cross-sectional view, and a cross-sectional view of a fiber-optic sensor according to some embodiments of the disclosure;

FIG. 2 illustrates a block diagram of a structure of a fiber-optic metal ion sensing apparatus;

FIGS. 3A and 3B respectively illustrate a fiber-optic metal ion detection apparatus according to two different embodiments of the disclosure;

FIGS. 4A and 4B respectively illustrate a reflection-mode and a transmission-mode fiber-optic sensing system according to two different embodiments of the disclosure;

FIGS. 5A and 5B respectively illustrate a fiber-optic sensing system according to two different embodiments of the disclosure;

FIG. 6 shows a flow chart of a metal ion detection method;

FIG. 7 illustrates a specific embodiment of the fiber-optic sensing system.

FIGS. 8A-8C respectively illustrate the experimental setup of a plasmonic fiber-optic sensing system for detecting Pb²⁺, a schematic of the measurement of Pb²⁺ by plasmonic gold-coated TFBG optical fiber sensor using DPASV method (WE: working electrode, CE: counter electrode, RE: reference electrode), and a photograph of gold-coated fiber-optic sensing probe (green dot line) and the electrodes;

FIG. 9 shows the current response of the Pb²⁺ sensor during the stripping phase of DPASV, where the bottom insets show the changes in chemical species over surface of gold film at different stages of the stripping process.

FIGS. 10A-10C respectively shows the spectral response of a gold-coated 18° TFBG sensor with SPR excitations for different content of deposited and stripped metallic lead, a magnified view (light gray illustration) of the SPR-coupled cladding mode spectral change (marked with a red asterisk); and a magnified view (dark gray illustration) of the spectrum near the core mode (Bragg) reference resonance;

FIG. 11 shows the optical sensor response over three consecutive DPASV cycles;

FIG. 12 shows the comparison of measured optical signal and electrical signal of Pb²⁺ during the 90 s stripping process (Upper panel), where the maximum value “stripping peak” of the transmission slope is marked with a red arrow, and in the lower panel, the SPR response describes the entire DPASV process, in which the optical response has been well recorded (320 s including deposition and stripping process) while the traditional electrochemical method can only record the stripping process (last 90 s);

FIGS. 13A-13F show the results of optical sensor measurements for Pb²⁺ samples with different concentrations, with FIGS. 13A and 13B showing the optical intensities during Pb²⁺ stripping for high and low concentrations, respectively; FIGS. 13C and 13D showing the derivatives of the optical signals for high and low concentrations, respectively; and FIGS. 13E and 13F showing the fits to the optical signals at the stripping peaks for high and low concentrations, respectively;

FIG. 14A shows the comparison of measured optical signal and electrical signal of Cu²⁺ during the 95 s stripping process. The maximum value “stripping peak” of the transmission slope is marked with a black arrow;

FIG. 14B shows the derivatives of the optical signals for detection heavy metal Cu²⁺ ions;

FIG. 15A shows the comparison of measured optical signal and electrical signal of a mixed solution of heavy metals Pb²⁺ and Cu²⁺ during the 95 s stripping process, where the “stripping peak” of the transmission slopes are marked with black arrows, respectively; and

FIG. 15B shows the derivatives of the optical signals for detection a mixed solution of heavy metals Pb²⁺ and Cu²⁺.

### DETAILED DESCRIPTION OF THE INVENTION

In a first aspect, this present disclosure provides a fiber-optic sensor configured to detect metal ions contained in a solution. The fiber-optic sensor includes an optical fiber and a coating assembly that coats an outside of the optical fiber. The coating assembly is configured to be active to surface plasmon resonance (SPR), and the fiber-optic sensor is configured, when in contact with the solution, to generate surface plasmon waves at an interface between the coating assembly and the solution upon a compatible input light shedding into and propagating in the optical fiber.

The coating assembly is further configured to be electrically conductive to thereby allow the fiber-optic sensor to be used as a working electrode when characterizing the metal ions in the solution, and an outer surface of the coating assembly substantially provides a surface where redox reactions (i.e. reduction reaction and oxidation reaction) of the metal ions occur, causing a detectable change of the surface plasmon waves generated in the fiber-optic sensor. Detection of the change of the surface plasmon waves can derive information of the metal ions in the solution, such as the determination of the identities and quantifications of the metal ions contained in the solution. In the fiber-optic sensor disclosed herein, the optical fiber can have a tilted grating in the core thereof, but can also be of other types. There are no limitations herein.

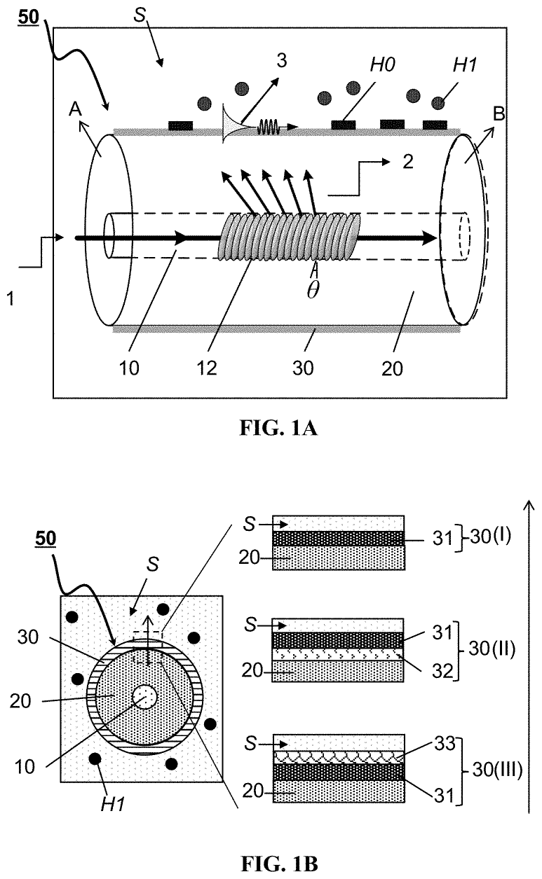

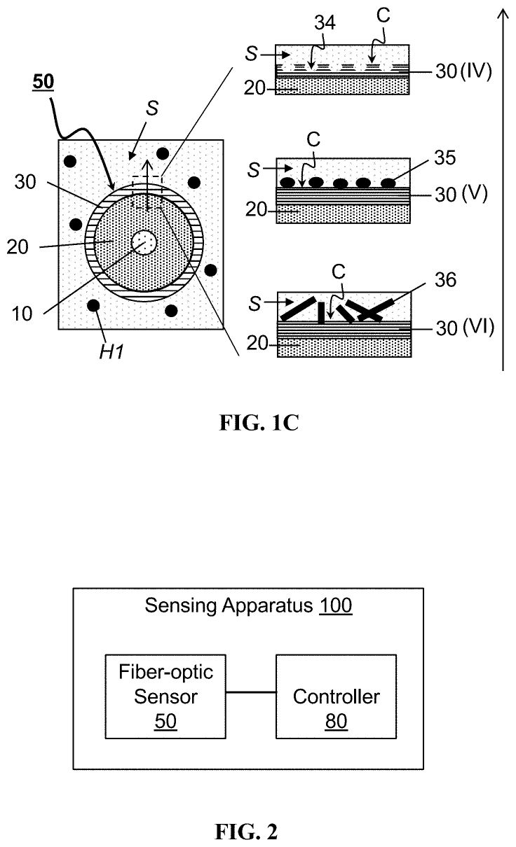

FIGS. 1A and 1B respectively illustrate a perspective view and a cross-sectional view of a fiber-optic sensor according to some embodiments of the disclosure.

FIG. 1A illustrates a perspective view, and a working mechanism of the fiber-optic sensor 50 in contact with a solution S containing metal ions H1. As illustrated, the fiber-optic sensor 50 includes a core 10 and a cladding 20, which are arranged coaxially to together form an optical fiber. A coating assembly 30 encircles, and thereby coats, an outside of the cladding 20 of the optical fiber, with its outer surface exposing to the solution S to thereby allow electrochemical reactions, i.e. redox reactions (i.e. reduction reaction and oxidation reaction) of the metal ions H1 to occur thereon. The coating assembly 30 is configured to be both active to surface plasmon resonance (SPR) and electrically conductive, allowing the fiber-optic sensor to serve both as an optical signal detector and as a working electrode of a metal ion detection apparatus 100 that will be described below in more detail.

Specifically regarding the redox reactions of the metal ions H1 in the solution, in a reduction step (or deposition step) of the detection method using the fiber-optic sensor 50, the metal ions H1 in the solution S are substantially reduced to becoming a corresponding solid metal element (or a metal solid substance) H0 that is deposited onto the outer surface of the coating assembly 30, whereas in an oxidation step (or stripping step) of the detection method (as provided below in more detail), the solid metal element H0 that attaches onto the outer surface of the coating assembly 30 of the optical fiber can be oxidized to becoming the metal ions H1 again that are stripped from the coating assembly 30 of the fiber-optic sensor 50 and dissolved into the solution S.

In this embodiment of the fiber-optic sensor, the core 10 of the optical fiber is provided with a tilted grating 12, i.e. a grating having an internal tilt angle θ (defined as an angle of each plane of the grating relative to a plane that is substantially perpendicular to the axis of the core 10). Upon an input light 1 entering from a first side surface A into the optical fiber and transmitting along the core 10, the tilted grating 12 can reflect and/or refract the input light into the cladding 20 of the optical fiber (the light such reflected or refracted is shown as 2 in FIG. 1A), exciting surface plasmon waves 3 at an interface between the coating assembly 30 and the solution S (also called a cladding mode of the optical fiber). The optical fiber evanesces the light containing plasma resonance waves to the environment outside the coating assembly 30, which interacts with the metal solid substance H0 attached onto the surface of the coating assembly 30 to cause energy loss and in turn, to change the amplitude of the wavelength of the resonance center. The optical signals thus generated can typically be captured in an optical spectrometer.

More specifically, when the metal solid substance H0 on the outer surface of the coating assembly 30 interacts with the plasmon resonance wave 3, the amplitude of the absorption envelope in the cladding mode changes correspondingly, and the direction of the amplitude change is correlated to the deposition and dissolution process of metal solid substance H0 on the surface of the coating assembly 30. The maximum slope of the amplitude change corresponds to the peak value of metal dissolution/stripping, and the amplitude change value is related to the concentration of the metal ions H1 in the solution S. In other words, the state of change of the metal ion ions H1 on the surface of fiber-optic sensor 50 can be modulated by the wavelength amplitude of the absorption envelope of the plasma resonance wave. Specifically, by obtaining a derivative of the amplitude change of the surface plasmon resonance, it can clearly identify and detect the stripping peak potential of the metal ions H1 to thereby realize a specific recognition of the metal ions H1. As such, the detection of the metal ions H1 can be converted from a current-based detection to an optical-electrochemical signal-based detection, so the detection system disclosed in this embodiment can simultaneously obtain optical and electrochemical quantities and can be analyzed to obtain the internal relationship therebetween.

In addition, the fiber-optic sensor 50 can also reflect optical waves at certain wavelengths in the core 10 of the optical fiber (i.e. core-mode optical waves, not shown in the above drawings) which, if detected, can be used as an inherent reference when doing the analysis of the surface plasmon waves 3 to thereby remove the unwanted influence, or interference, due to fluctuations from certain factors, such as those from the environment (e.g. temperature) or those from the sensing system (e.g. light source level). As such, the fiber-optic sensor 50 disclosed herein can have a feature of being capable of self-calibration or self-correction.

The fiber-optic sensor 50 also has a second side surface B opposing to the first side surface A, and could be a light emitting surface (e.g. for a transmission-mode optical fiber), or could be a light reflecting surface (e.g. for a reflection-mode optical fiber). In the latter case, a mirror can be arranged on the second side surface, and will be described below in more detail. The cross-sectional view of the fiber-optic sensor 50 as shown in FIG. 1A is further illustrated in FIG. 1B and FIG. 1C. As illustrated in FIGS. 2B and 2C, in the fiber-optic sensor 50, the core 10 and the cladding 20 are arranged coaxially, and the coating assembly 30 coats an outer surface of the cladding 20 of the optical fiber, and has its outer surface in direct contact with the medium M.

As further illustrated in FIG. 1B, the coating assembly 30 can have different configurations according to different embodiments. According to a first configuration (I), the coating assembly 30 substantially includes one single film layer, or base film layer 31 that has its inner surface coating the cladding 20 of the optical fiber and its outer surface exposed to the solution S. The base film layer 31 itself is configured to contain a composition that allows it to be both electrically conductive and active to surface plasmon resonance (SPR). Optionally, the base film layer 31 can have a metal composition, such as gold (Au), silver (Ag), platinum (Pt), aluminum (Al), or copper (Cu), etc., or their combinations (i.e. alloy). Other compositions of the base film layer 31 can optionally be a semiconductor material, a conductive metal oxide material (e.g. SnO₂), a two-dimensional (2D) material such as graphene, 2D carbide/nitride material, etc., or an optical metamaterial. There are no limitations herein.

Optionally, according to a second configuration (II) illustrated also in FIG. 1B, in addition to the base film layer 31 as in the first configuration (I), the coating assembly 30 further includes a transition film layer 32, which is sandwiched between the outer surface of the cladding 20 (i.e. the upper surface thereof in the figure) of the optical fiber and an inner surface (i.e. the lower surface thereof in the figure) of the base film layer 31. The transition film layer 32 is configured to improve adhesion of the composite film layer 31 to the optical fiber. Non-limiting examples of the compositions that can be used for the transition film layer 32 can include titanium (Ti), molybdenum (Mo), or chromium (Cr), or their combination thereof.

Optionally, according to a third configuration (III) illustrated also in FIG. 1B, in addition to the base film layer 31 as in the first configuration (I) and in the second configuration (II), the coating assembly 30 further includes a conductive protective film layer 33, which is arranged over an outer surface of the base film layer 31 to thereby be exposed to the solution S, and is configured to protect the integrity of the base film layer 31. The conductive protective film layer 33 can comprise, for example, indium tin oxide (ITO), zinc peroxide (ZnO₂), tin oxide (SnO₂), indium oxide (In₂O₃), etc., or can comprise a silicon film layer, or a diamond film layer, etc. Furthermore, in the fiber-optic sensor, the outer surface of the coating assembly 30 (i.e. the surface thereof that is exposed to the solution 5) can optionally be modified to have an increased specific surface area (compared with an otherwise smooth surface), so as to elevate the metal ion enrichment capability, which in turn can lead to an improved conductivity, sensitivity, and response rate of the fiber-optic sensor 50, and can also lead to a larger measurement range for the metal ion concentrations.

For this purpose, according to different embodiments, the outer surface of the coating assembly can be configured to comprise one or both of a plurality of subtractive microstructures and a plurality of additive microstructures. Herein and throughout the disclosure, a microstructure is defined as a fine structure having a scale of nanometers or micrometers. FIG. 1C provides three illustrating embodiments (i.e. IV, V, and IV in the figure) of these microstructures.

Specifically, as illustrated in the embodiment (IV) in FIG. 1C, the outer surface C of the coating assembly 30 can comprise a plurality of subtractive microstructures, which comprise porous microstructures, having a plurality of cavities (or pores) 34 that are in contact with the solution S. Alternatively, the plurality of subtractive microstructures can comprise winkle-like microstructures (not shown). It is noted that any of the above reductive microstructures (i.e. porous, winkle-like, or alike) can form on the base film layer 31, the conductive protective layer 33, and/or the transition film layer 32, depending on the specific configurations (I, II, or III) and the depth of the cavities or pores.

As further illustrated in the embodiments (V and VI) shown in FIG. 1C, the outer surface of the coating assembly 30 can be modified with a plurality of additive microstructures, such as particles 35 (e.g. nanoparticles, as illustrated in V), tubes 36 (e.g. nanotubes, as illustrated in VI), films (e.g. nanofilms, not shown), other irregular structures, or their combinations. These additive microstructures are also configured to be electrically conductive. Examples of the compositions for these additive microstructures can include graphite, graphene, carbon nanoparticles, carbon nanotubes, a metal oxide, a two-dimensional material, or an optical metamaterial.

Herein, the input light 1 as referred to above and illustrated in FIGS. 1A and 1B shall be understood as suitable electromagnetic radiation emitted by a light source that can, upon reflection and refraction by the tilted grating 12 in the core 10 of the optical fiber, excite or induce the generation of surface plasmon waves 3 at an interface between the coating assembly 30 and the solution S to allow the analysis of the amplitude change of the absorption envelope in the cladding mode to derive information of the metal ions H1 in the solution S. Preferably the input light 1 can be a polarized light having a polarization direction substantially parallel to an inscription direction (e.g. each plane of the grating 12) of the tilted grating 12 in the core 10 of the optical fiber. Yet a non-polarized light, or a polarized light with a polarization direction other than that perpendicular to the inscription direction of the tilted grating 12 can also be used as the input light 1 to thereby excite the generation of the surface plasmon waves 4.

Furthermore, in any of the embodiments of the fiber-optic sensor as described above, the optical fiber can have components, compositions, dimensions, and/or configurations of the optical fibers mentioned in any of the embodiments that follow, such as those use for telecommunications-grade optical fiber (e.g. Corning SMF-28), but can also have other parameters.

In the three embodiments of the coating assembly 30 as described above, the base film layer 31 can have a thickness in a range of 20-70 nm, for example, in a range between 30-50 nm. The tilted grating 12 in the optical fiber of the fiber-optic sensor 50 can be obtained by means of an excimer laser and a phase mask, or by a double beam interference; and the tilted grating 12 can have an inclination angle of more than approximately 2°, and preferably between 6°-22°. The metal ions that can be detected by the fiber-optic sensor disclosed herein can include ions of both heavy metal and transition metals. Non-limiting examples of the metal whose ions can be detected by the fiber-optic sensor include including lead (Pb), mercury (Hg), copper (Cu), zinc (Zn), cobalt (Co), ion (Fe), nickel (Ni), arsenic (Ar), chromium (Cr), etc. It is also possible to differentiate between the different type of ions of a same metal, such as Fe²⁺/Fe³⁺, Co²⁺/Co³⁺, Cu⁺/Cu²⁺, etc. Other metal ions are also possible.

In a second aspect, a fiber-optic metal ion detection apparatus (or referred to as “detection apparatus”, “sensing apparatus” throughout the disclosure) comprising any of the embodiments of the fiber-optic sensor as described above in the first aspect is further provided.

FIG. 2 illustrates a block diagram of a structure of a fiber-optic metal ion sensing apparatus according to some embodiments of the disclosure. As shown in FIG. 2A, in addition to the fiber-optic sensor 50, the metal ion sensing apparatus 100 further includes a controller 80 which is electrically connected with the coating assembly of the fiber-optic sensor. The controller 80 is configured to provide an adjustable potential thereto such that when the coating assembly of the fiber-optic sensor is in contact with the solution, redox reactions (i.e. the reduction reaction and the oxidation reaction) of each of the at least one metal ion occur on an outer surface of the coating assembly, resulting in a detectable change of the surface plasmon waves generated in the fiber-optic sensor. The change of the surface plasmon waves contains information of the each of the at least one metal ion in the solution, and analysis over the change of the surface plasmon waves can derive information, such as the identities, and the concentrations of each of the at least one metal ion. According to some embodiments, the controller can comprise an electrochemical station.

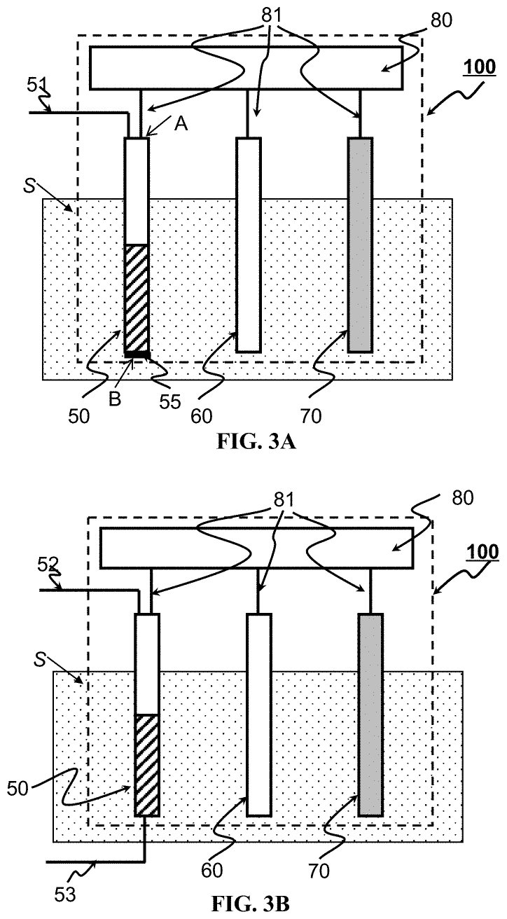

FIGS. 3A and 3B respectively illustrate a fiber-optic metal ion detection apparatus 100 according to two different embodiments of the disclosure. As shown in both figures, besides the fiber-optic sensor 50 which also serves as a working electrode, the fiber-optic metal ion detection apparatus 100 also includes a reference electrode 600, a counter electrode 700 and an electrochemical station 80. All of the three electrodes (i.e. the fiber-optic sensor/working electrode 50, the reference electrode 600 and the counter electrode 700) are submerged into the solution S containing the metal ion(s) to be tested. Through an electrical wiring 81, each of the three electrodes is electrically connected with the electrochemical station 80. The electrochemical station 80 is configured to provide electrical potentials to each of the three electrodes to thereby control the operation of the fiber-optic metal ion detection apparatus 100 to allow the fiber-optic sensor 50 to collect the optical signals for the identification and/or quantification of the metal ions in the solution. In addition, the fiber-optic sensor 50 is optically connected to other components for the input and/or output of optical signals. Depending on the different working modes, the fiber-optic sensor 50 can have two different configurations: a reflection mode and a transmission mode, as illustrated in FIGS. 2A and 2B, respectively.

In the reflection mode shown in FIG. 3A, the fiber-optic sensor 50 is substantially in a form of a probe, having one end optically connected with an optical path 51 that serves both as an incident light transmission pathway and as an output optical signal transmission path and another end B which is submerged into the solution to be tested. More specifically, in the fiber-optic metal ion detection apparatus 100, the reflection-mode fiber-optic sensor 50 has a first end A from which the input lights are transmitted through the optical path 51 to shed into the fiber-optic sensor 50 and the SPR optical signals are outputted to the optical path 51; and it also has a second end B that opposes to the end A, which is provided with a mirror 55 having a reflective surface facing to, and configured to reflect the optical signals back towards, the first end A of the optical fiber. In the transmission mode shown in FIG. 3B, the fiber-optic sensor 50 is optically connected to a first optical path 52 configured to input an incident light to the fiber-optic sensor 50, and is further optically connected a second optical path 53 configured to output the SPR optical signals generated in the fiber-optic sensor 50. Among the two modes as described above, a fiber-optic sensor 50 with the reflection mode has relatively more flexibility and convenience to allow direct submersion thereof into, and removal from, the solution S.

In a third aspect, a sensing system comprising any of the embodiments of the fiber-optic metal ion detection apparatus as described above in the second aspect is provided.

In addition to the fiber-optic metal ion detection apparatus, the sensing system further includes a light source apparatus and a signal detection apparatus, which are both optically and communicatively coupled with the fiber-optic metal ion detection apparatus, and are configured respectively to provide an input light into the sensing apparatus, and to receive signals of the surface plasmon waves from the fiber-optic sensing device, so as to derive the information of the metal ions in the solution for the identification and quantification thereof. More specifically, the light source apparatus is optically coupled to a first end of, and configured to provide an input light into, the fiber-optic metal ion detection apparatus so as to allow the electromagnetic radiation to propagate in the optical fiber of the fiber-optic sensor of the fiber-optic metal ion detection apparatus; and the signal detection apparatus is coupled to the fiber-optic metal ion detection apparatus and configured to receive the signals of the surface plasmon waves therefrom.

Depending on the two different working modes (i.e. the reflection mode and the transmission mode) of the fiber-optic sensor in the fiber-optic metal ion detection apparatus, the sensing system has different configurations.

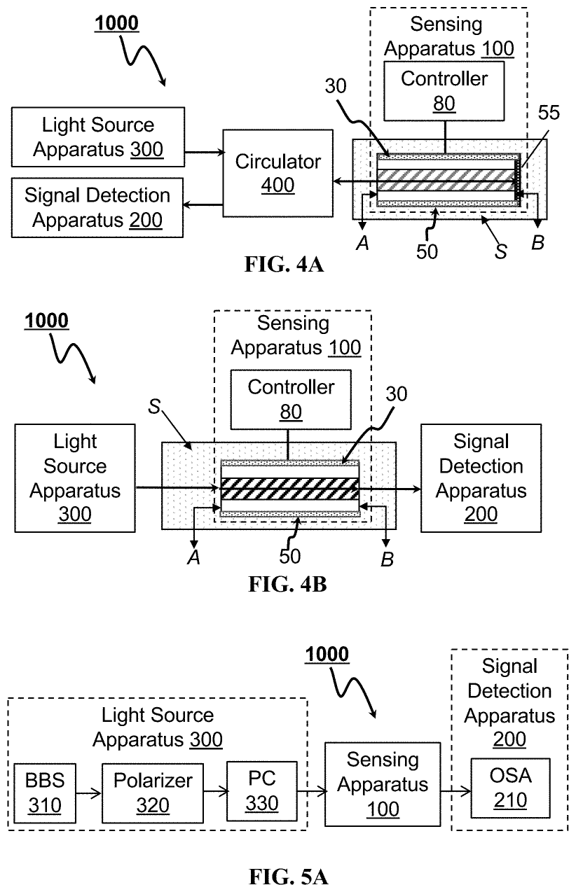

FIG. 4A is a block diagram of a reflection-mode fiber-optic sensing system according to some embodiments of the disclosure. As shown, the light source apparatus 300 and the signal detection apparatus 200 are substantially arranged over a same side of the fiber-optic metal ion detection apparatus 100. Specifically, the light source apparatus 300 and the signal detection apparatus 200 are both optically coupled to the first end A of the fiber-optic sensor 50 of the fiber-optic metal ion detection apparatus 100, whereas the second end B is provided with a mirror 55. Then after reflection at the second end B of the fiber-optic sensor 50 by the mirror 55, reflected light can transmit back through the first end A to be received by the signal detection apparatus 200. In order to separate an input optical pathway and an output optical pathway to thereby allow the signal detection apparatus to obtain the signals of the surface plasmon waves from the sensing apparatus without being influenced by the input light, the sensing system 1000 further comprises an optical fiber circulator 40000, which is arranged between the light source apparatus 300 and the sensing apparatus 100 along the input optical pathway and between the sensing apparatus 100 and the signal detection apparatus 200 along the output optical pathway.

FIG. 4B is a block diagram of a transmission-mode fiber-optic sensing system according to some embodiments of the disclosure. As shown, the fiber-optic sensing system 1000 includes a fiber-optic metal ion detection apparatus 100, which is optically and communicatively arranged between a light source apparatus 300 and a signal detection apparatus 200 along a direction of light transmission (as shown by the rightward arrows in the figure). In other words, the light source apparatus 300 is optically coupled to the light-incident surface A of the fiber-optic sensor 50 and thus sends an input light through the light-incident surface A into the fiber-optic sensor 50 (as shown by the block with a pattern of inclining lines in the figure) of the fiber-optic metal ion detection apparatus 100, whereas the signal detection apparatus 200 is optically coupled to the light-emitting surface B of the fiber-optic sensor 50, and thus receives optical signals (i.e. signal of the SPR waves and core-mode optical waves) transmitted through the light-emitting surface B from the fiber-optic metal ion detection apparatus 100.

In both of FIGS. 4A and 4B, the controller 80 in the sensing apparatus 100 is electrically connected with the conductive coating assembly 30 on the fiber-optic sensor 50.

In any one embodiment of the fiber-optic sensing system 100 described above, the light source apparatus 300 can include a light source, a polarizer, and a polarization controller (PC). Herein the light source can be a broadband source (BBS) or a tunable laser source (TLS). Light emitted from the light source can be converted into a polarized light having a polarization direction substantially parallel to an inscription direction of the tilted grating after the emitted light transmits through the polarizer and the polarization controller.

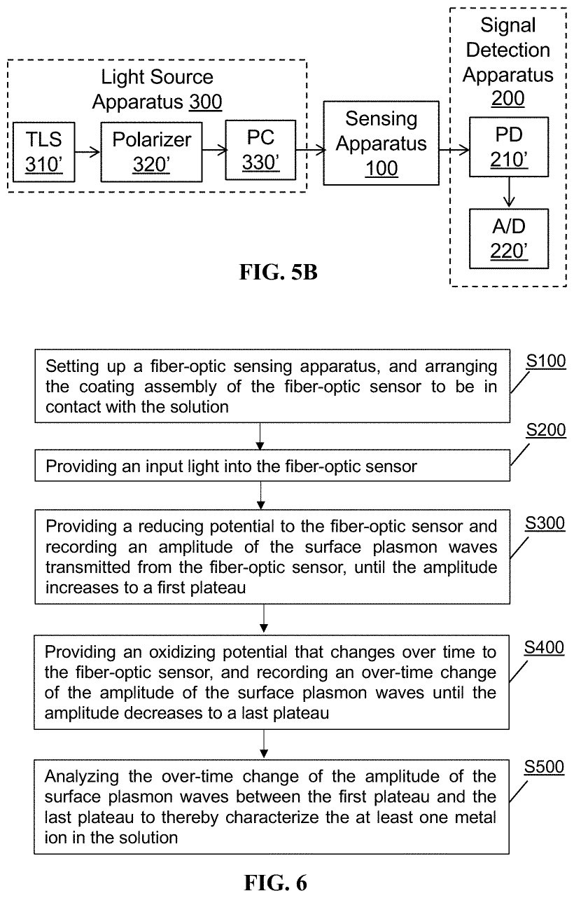

According to some embodiments of the fiber-optic sensing system 1000 as illustrated in FIG. 5A, the light source apparatus 300 can include a broadband source (BBS) 310, a polarizer 320, and a polarization controller (PC) 330, and in accordance, the signal detection apparatus 200 comprises an optical spectrum analyzer (OSA, or can be referred to as “optical spectrometer”) 210. The broadband source (BBS) 310 can provide a broadband input light, which can be converted, via the polarizer 320 and the polarization controller (PC) 330, into a polarized light with aforementioned polarization direction before it enters into the optical fiber of the sensing apparatus so as to excite surface plasmon waves on the surface of the sensing apparatus 100. The optical spectrum analyzer (OSA) 210 is configured to analyze, via a spectral interrogation, the signals of the surface plasmon waves transmitted from the sensing apparatus 100 to quantify a wavelength shift and optical intensity change induced by a refractive index change of the sensing apparatus 100 so as to in turn derive information of, or characterize, the metal ion(s) in the solution.

According to another embodiments of the sensing system 1000 as illustrated in FIG. 5B, the light source apparatus 300 can include a tunable laser source (TLS) 310′, a polarizer 320′, and a polarization controller (PC) 330′, and in accordance, the signal detection apparatus 200 comprises an optical detector (PD) 210′ and an analog-to-digital converter (A/D) 220′. The tunable laser source (TLS) 310′ is configured to provide an input light with a pre-determined narrow band, such as comprising a light with a second wavelength matching a predetermined first wavelength. A light with the predetermined first wavelength has been determined in advance to be able to produce one of the most sensitive modes of surface plasmon waves on the sensing apparatus, upon being inputted into the sensing apparatus. The pre-determination can be performed utilizing the embodiments of the sensing system as illustrated in FIG. 5A, where the sensing apparatus 100 is coupled to a broadband source (BBS) 310, a polarizer 320, a polarization controller (PC) 330, and an optical spectrum analyzer (OSA, or “optical spectrometer”) 210 in a configuration illustrated in FIG. 5A. The broadband source (BBS) 310 is configured to provide a broadband input light, whereas an optical spectrum analyzer (OSA) 210 is configured to analyze at which wavelength the input light can generate one of the most sensitive modes of surface plasmon waves on the sensing apparatus 100.

The input light is further converted, via the polarizer 320′ and the polarization controller (PC) 330′, into a polarized light with aforementioned polarization direction before it enters into the optical fiber of the sensing apparatus so as to excite surface plasmon waves on the surface of the sensing apparatus 100. The optical detector 210′ is configured to detect, and to convert into analog electrical signals, the signals of the plasmon waves from the sensing apparatus 100. The analog-to-digital converter 220′ is further configured to convert the analog electrical signals into digital electrical signals, based on which an interrogation can be performed over a quantification of intensity variations to thereby derive the information of the metal ion(s) in the solution.

According to some embodiments of the sensing system, the signal detection apparatus is further configured to receive signals of other optical waves refracted by the grating and transmitted in the core of the optical fiber in the fiber-optic sensor of the sensing apparatus (i.e. core mode) for the calibration or correction over noise information (temperature, light source jittering, etc.) in the information of the each of the at least one metal ion in the solution.

Using the sensing system as disclosed herein, a measurement range for the concentrations of the at least one metal ion in the solution can be around 10⁻⁴-10⁻¹⁰ M, and a limit of detection (LOD) of <10⁻¹⁰ M can be achieved. In addition, the metal ions that can be characterized using the sensing system disclosed herein can comprise ions of one or more of lead (Pb), mercury (Hg), copper (Cu), zinc (Zn), cobalt (Co), ion (Fe), nickel (Ni), arsenic (Ar), or chromium (Cr).

In a fourth aspect, a metal ion detection method utilizing the fiber-optic sensing apparatus as described above in the second aspect is further provided.

FIG. 6 shows a flow chart of a detection method for detecting at least one metal ion in a solution according to some embodiments of the disclosure. As shown, the detection method includes the following steps:

S100: Setting up a fiber-optic sensing apparatus, and arranging the coating assembly of the fiber-optic sensor to be in contact with the solution;

S200: Providing an input light into the fiber-optic sensor;

S300: Providing a reducing potential to the fiber-optic sensor and recording an amplitude of the surface plasmon waves transmitted from the fiber-optic sensor, until the amplitude increases to a first plateau;

S400: Providing an oxidizing potential that changes over time to the fiber-optic sensor, and recording an over-time change of the amplitude of the surface plasmon waves until the amplitude decreases to a last plateau; and

S500: Analyzing the over-time change of the amplitude of the surface plasmon waves between the first plateau and the last plateau to characterize the at least one metal ion in the solution.

In the method as described above, each of the reducing potential (in step S300) and the oxidizing potential (in step S400) is provided to the fiber-optic sensor (more specifically, the coating assembly) by means of the controller in the fiber-optic sensing apparatus. The reducing potential is substantially a first potential which, upon application to the fiber-optic sensor by the controller, allows each of the at least one metal ion in the solution to be reduced into a corresponding solid metal element that deposits onto the outer surface of the coating assembly. The oxidizing potential is substantially a second potential which, upon application to the fiber-optic sensor by the controller, allows the solid metal element corresponding to each of the at least one metal ion to be oxidized to thereby become its ion form to thereby strip from the coating assembly into the solution. The oxidizing potential is configured to change over time in a direction reverse to the reducing potential. Optionally, the reducing potential is configured to be a substantially constant potential, and the oxidizing potential is configured to change at a substantially constant rate over time.

Herein, characterization of the at least one metal ion in the solution can include identification, i.e. determination of the identity, of each metal ion in the solution, and can also include quantification, i.e. determination of the concentration, of each metal ion in the solution.

In the method disclosed herein, the determination of the identity of one particular metal ion relies on the identification of a locally fastest change of the amplitude of the surface plasmon waves. It can be realized by taking a derivative at each point of a curve corresponding to the over-time change of the amplitude of the surface plasmon waves between the first plateau and the last plateau to thereby obtain a derivative-over-time curve. The identity of each metal ion can be determined by identifying a characteristic trough (or peak) corresponding thereto on the derivative-over-time curve. Each trough (or peak) substantially corresponds to a locally fastest amplitude change on the derivative-over-time curve, with a characteristic position.

If there is only one metal ion to be investigated, there is only one trough, whose position on the derivative-over-time curve can be used to determine the identity of the metal ion. If there are two or more metal ions in the solution, an equal number of troughs can show up on the derivative-over-time curve, each with its characteristic position telling the identity of each metal ion in the solution.

In the method disclosed herein, the determination of the concentration of one particular metal ion relies on the calculation of the amplitude change of the surface plasmon waves on the amplitude-over-time curve, which is correlated to the concentration of the metal ion.

Specifically, using the method as described above, if there is only one metal ion to be investigated, only two plateaus (i.e. the first plateau, and the last plateau) in the amplitude-over-time curve are observed, and such amplitude decrease (i.e. the difference between the first plateau and the last plateau) can be plotted against a pre-determined standard curve to thereby obtain the concentration of the metal ion. Herein the pre-determined standard curve is obtained in advance by plotting a set of sample solutions, each with a known yet different concentration of the same metal ion. Optionally, the standard curve can be a linear curve, obtained by plotting an amplitude change of the surface plasmon waves relative to Log M for each sample solution, where M is a concentration of the same metal ion in each sample solution.

Using the method as described above, if there are N (N>1) metal ions to be investigated, one the amplitude-over-time curve, there will be N−1 plateaus between the first plateau and the last plateau, together forming a sequence of plateaus [P₀, P₁, P₂, . . . , P_{N}] in a sequentially decreasing manner, where P₀ represents the first plateau and P_{N} the last plateau. In order to calculate the concentration for each of the N metal ions, a sequence of N amplitude changes are obtained, each calculated by taking an amplitude difference between every two neighboring plateaus in the sequence of plateaus, which can be expressed as [P₁-P₀, P₂-P₁, . . . , and P_{N}-P_{N-1}]. In a manner similar to the single metal ion concentration calculation, each amplitude change is plotted against a pre-determined standard curve specific to that particular metal ion to thereby obtain the concentration thereof.

In the method as described above, the core-mode optical signals (i.e. the optical waves generated and transmitted in the core of the optical fiber in the fiber-optic sensor) can be optionally utilized for the calibration or correction of noise caused by the environment or the system (such as the temperature or the light source jittering, etc.).

Because the fiber-optic sensor, sensing apparatus, system and method as provided herein relies on an optical fiber sensor, they has advantages such as anti-electromagnetic interference, high sensitivity, low loss, long life, light weight and low cost, etc.

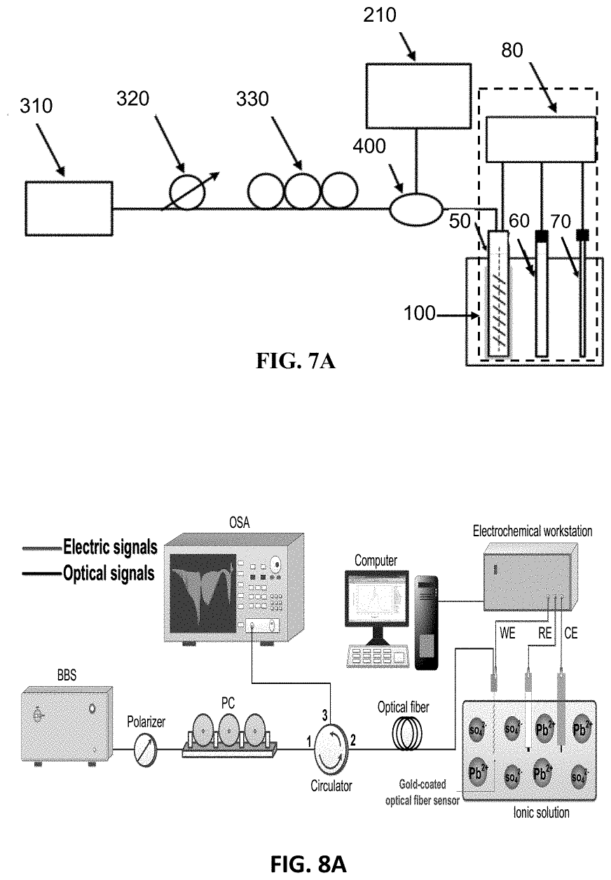

In the following, one specific embodiment of the sensing system is provided as an illustrating example. As illustrated in FIG. 7, the sensing system includes a light source 310, a polarizer 320, a polarization controller 33030, an optical fiber circulator 40000, a optical spectrometer 210, and a metal ion sensing apparatus 100. The metal ion sensing apparatus 100 includes an electrochemical workstation 80 (i.e. controller), a fiber-optic sensor 50, a reference electrode 600 and a counter electrode 700. The light source 310, the polarizer 320, the polarization controller 33030, and the optical fiber circulator 40000 are optically connected in a sequential manner. The optical spectrometer 210 is optically connected with the optical fiber circulator 40000. The fiber-optic sensor 50 is optically connected with the optical fiber circulator 400 and the electrochemical workstation 8 respectively. The reference electrode 600 and the counter electrode 700 are electrically connected with the electrochemical workstation 8 respectively. In this embodiment, the reference electrode 600 comprises an Ag/AgCl reference electrode; and the counter electrode 700 comprises a Pt counter electrode. The fiber-optic sensor 50, the reference electrode 600 and the counter electrode 700 are all submerged into a solution containing heavy metal ion(s) to be measured. The fiber-optic sensor 50 includes an optical fiber engraved or inscribed with a tilted grating, and the outer surface of a cladding of the optical fiber is coated with a metal film having a uniform thickness at a nanometer scale (i.e. it is substantially the SPR-active and conductive coating assembly 30 in the fiber-optic sensor 50 illustrated in FIGS. 1A-1C). In the metal ion sensing apparatus 100, the fiber-optic sensor 50 serves substantially as a working electrode of the electrochemical workstation 80. Because the metal film is coated on the surface of the optical fiber, the working electrode is not only a plasma resonance optical signal sensor, but also has good conductivity. In this embodiment, the metal ion is Pb²⁺ ion.

A light emitted by the light source 310 sequentially passes through the polarizer 320, the polarization controller 33030 and the optical fiber circulator 40000, and then sheds into the fiber-optic sensor 50 whose core is engraved with the tilted optical fiber grating. A cladding mode generated in the optical fiber is coupled to the metal film to thereby stimulate a surface plasmon resonance (SPR) of the metal film. The fiber-optic sensor 50 evanesces the light containing plasma resonance waves to the environment outside the metal film, which interact with the heavy metal elements (i.e. the solid heavy metal Pb element) attached onto the surface of the metal film to cause energy loss and in turn to change the amplitude of the wavelength of the resonance center. This above phenomenon can be detected in the optical spectrometer 210.

When the heavy metal element on the surface of the metal film interacts with the plasmon resonance wave, the amplitude of the absorption envelope changes correspondingly, and the direction of the amplitude change is related to the deposition and dissolution process of heavy metal element on the surface of metal film. The maximum slope of the amplitude change corresponds to the peak value of heavy metal dissolution, and the amplitude change value is related to the concentration of the heavy metal ion Pb²⁺ in the solution. In other words, the state of change of the heavy metal ion Pb²⁺ on the surface of fiber-optic sensor 50 can be modulated by the wavelength amplitude of the absorption envelope of the plasma resonance wave. Specifically, by obtaining a derivative of the amplitude change of the surface plasmon resonance, it can clearly identify and detect the stripping peak potential of the heavy metal ion Pb²⁺ to thereby realize a specific recognition of the heavy metal ion Pb²⁺. As such, the detection of the heavy metal ion Pb²⁺ can be converted from a current-based detection to an optical-electrochemical signal based detection, so the detection system disclosed in this embodiment can simultaneously obtain optical and electrochemical quantities and can be analyzed to obtain the internal relationship therebetween. The sensing system is configured to measure the change of the amplitude of the waves of the SPR to thereby obtain information about the concentration of the heavy metal ion by calculating a maximum value of a rate of the change of the amplitude of the waves of the SPR to determine a peak electrical potential of a stripping process of the heavy metal ion to thereby determine a type of the heavy metal ion.

In this specific embodiment of the sensing system, the light source 310 comprises a broadband source (BBS) having an output spectrum ranging from 1250-1650 nm, and the output spectrum operably matches an envelope range of a transmission spectrum of the tilted grating in the optical fiber of the fiber-optic sensor 50. The tilted grating in the optical fiber of the fiber-optic sensor 50 is obtained by means of an excimer laser and a phase mask, and has an inclination angle of approximately 18 degrees, and has an axial length of 10-20 mm.

Furthermore, in this embodiment of the system, the metal film on the fiber-optic sensor 50 in optical fiber sensing probe is fabricated by magnetron sputtering, and the metal film has a thickness of 30-50 nm, which ensures the best excitation efficiency of plasma. In the process of coating the nanometer-thick metal film, the target is fixed, and the optical fiber rotates at a uniform speed along its own axis to ensure the uniformity of thickness of the metal film. The metal film comprises a gold film, which ensures that it can not only effectively excite the plasma resonance wave, but also have good conductivity. The gold film coated on the outer surface of the cladding of the optical fiber is also very stable. The heavy metal element can attach onto the surface of the gold film well, or can strip from the surface of the gold film. The surface of the gold film can also be modified with nanoparticles or nanofilms, such as graphene, carbon nanotubes, and other two-dimensional materials, so as to increase the specific surface area of the fiber-optic sensor 50, to elevate the ion enrichment capability, and to improve the conductivity.

This embodiment of the disclosure further provides an electrochemical plasmonic fiber-optic sensing method for detecting heavy metal ions in a solution. The method is substantially based on the detection system as described above, and comprises the following steps:

S1: The solution was prepared with different concentration gradients according to the standards, and the after-cleaning fiber-optic sensor 50, the reference electrode 60 and the counter electrode 70 were submerged into the prepared solution containing the heavy metal ion to be tested.

S2: The light source 310, the polarizer 320, the polarization controller 330, and the optical fiber circulator 400 were sequentially and operably connected to thereby set up an optical path, which is configured such that a light emitted from the light source 310 is converted into a polarized light after passing through the polarizer 320, a polarization direction of the polarized light is then adjusted by the polarization controller 330 to be substantially same as a writing direction of the tilted grating in the fiber-optic sensor 50, and lights in the optical path were ensured, by observing changes of an output spectrum of the optical spectrometer 210, to be in a polarized state capable of exciting surface plasma resonance (SPR) on a metal film coated on the optical fiber of the fiber-optic sensor 50.

In this step, the polarized light is a polarized light that is parallel to the writing direction of the tilted optical fiber grating, which was determined by the peak amplitude of the plasma resonance wave excited by the metal film surface on the outer surface of the optical fiber cladding. That is, the peak amplitude of the surface plasma resonance wave is maximum when the polarized light is parallel to the writing direction of the tilted optical fiber grating.

S3: The electrochemical workstation 8 was operably connected to a computer to thereby set up an electrical circuit, and relevant parameters were set up through a software running on the computer. The indoor temperature was controlled to be a normal and constant temperature, and the external environment was also maintained to be constant so that the detection process is not disturbed.

S4: The heavy metal ion detection apparatus 100 was arranged to stand still under a natural condition, and then the optical-based and the electrochemical-based approaches were simultaneously applied to detect the heavy metal ion Pb²⁺ in the heavy metal ion-containing solution to be tested. The specific operations are as follows:

A constant electric potential of −1.40 V was first applied, by means of the electrochemical workstation 8, to each of the three electrodes (i.e. the working electrode 5, the reference electrode 60, and the counter electrode 70) of the heavy metal ion detection device 10, so as to allow the heavy metal ion (Pb²⁺) 15 in the solution to, under this voltage excitation, be reduced to the solid substance 14 deposited on the working electrode (i.e. the fiber-optic sensor 50). This process lasted for 230 seconds.

A reverse voltage was then applied to the three electrodes of the heavy metal ion detection apparatus 100 to oxidize the heavy metal Pb solid substance 14 deposited on the working electrode 5, and during the dissolution (or stripping) process, the heavy metal solid substance Pb deposited on the surface of the working electrode are oxidized into heavy metal ion Pb²⁺ that dissolves back into the solution. An oxidation current is generated in this process, and the highest peak in the voltammetry curve is the stripping peak of the heavy metal ion Pb²⁺, and correspondingly the change rate of the plasma resonance responsive curve tends to be the largest. The electrochemical workstation 8 and the optical spectrometer 210 were used to record the relevant data of the above process, and a corresponding stripping potential voltammetric curve was drawn, which was used for reference and calibration of the optical output signals of the optical fiber plasma resonance wave.

Specific experiments using the above metal ion detection system are provided below with more details.

Method and System

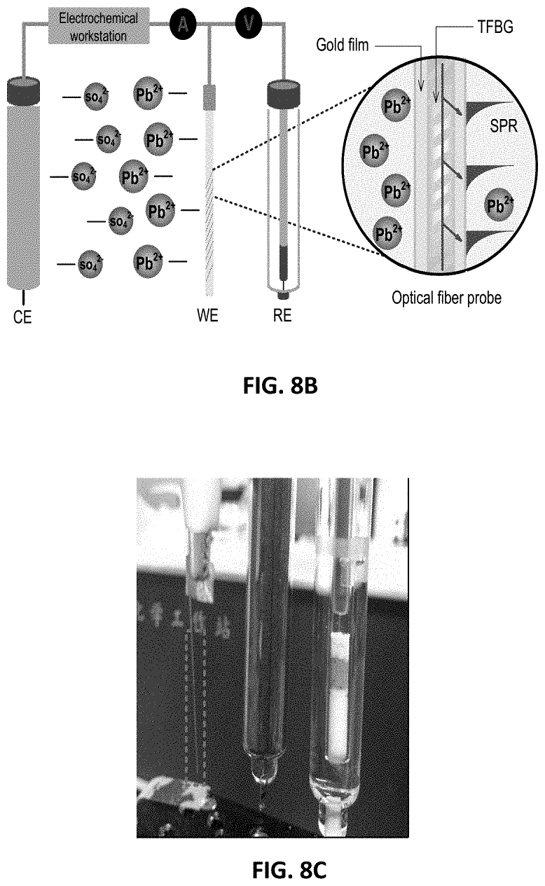

The optical system for detecting heavy mental ions is an all-fiber-coupled EC-SPR fiber-optical sensing system, as shown in FIG. 8A (take Pb²⁺ as an example). The optical setup includes a broadband source (BBS) emitting over a wavelength range of 1250-1650 nm, a polarizer, a polarization controller (PC), a circulator, the optical fiber sensor probe and an optical spectrum analyzer (OSA) with a resolution of 0.02 nm. The electrical part of the heavy metal ions detection system consists of an electrochemical workstation, a working electrode, an Ag/AgCl reference electrode, a counter electrode and a computer. The electrochemical workstation is used as a voltage supply device in this experiment. After connecting all three electrodes, the parameters of the electrochemical method of ASV can be set.

FIG. 8B shows a schematic of an electrochemical three-electrode system using an optical fiber sensor probe as the working electrode. A TFBG with a tilt angle of 18° was photo-inscribed into standard, 125-μm diameter single mode optical fiber. A 50-nm thick gold film was deposited on the surface of the fiber containing the TFBG, over a length of 30 mm, with a tab of electrically conductive copper tape attached to the gold coating as an electrical contact. The gold coated optical fiber sensor acts as the working electrode in the electrochemical three-electrode system. A copper conductive strip is attached to the surface of the fiber-optic probe and then connected to the electrochemical workstation via an alligator clip wire, as the photograph shows in FIG. 8C.

The detection of heavy metal ions is based on differential pulse anodic stripping voltammetry (DPASV). In DPASV the analyte of interest is first electroplated onto the working electrode before being removed or stripped by applying an oxidizing potential (as a series of voltage pulses with increasing amplitude). In the present case, Pb²⁺ ions were first deposited onto the surface of the optical fiber electrode at a potential of −1.40 V. Then a reverse voltage was applied to oxidize the metal on the electrode. During the oxidation process, an oxidation current is generated. Since both the deposition and stripping processes for Pb²⁺ ions occur on the surface of the working electrode (the gold coated optical fiber sensor probe), they accordingly modify the excited surface plasmon resonances. By monitoring the optical transmission of the optical fiber, real-time and continuous monitoring of heavy metal ion concentration with high sensitivity was achieved.

DPASV keeping the parameters of the electrochemical workstation constant was used to ensure the consistency of the optical fiber sensor when detecting concentrations of different solutions. The optical fiber sensor was thoroughly cleaned before each change of solution. For each measurement, the deposition potential was kept at −1.40 V for a duration of 230 s (the optimum deposition time determined from analysis of multiple experimental runs). At the end of the deposition process, the applied potential on the working electrode was immediately switched to −1.30 V and then swept to +0.50 V at a constant rate. The −1.30 to +0.50 potential is approximately centered around the −0.40 V stripping potential for Pb²⁺ ions (Gomaa H et al., 2018). After cleaning the sensor, the next round of testing can be performed. When the electrochemical workstation is operating in DPASV mode, both the electrochemical and spectroscopic optical signals can be simultaneously recorded.

Results and Discussion

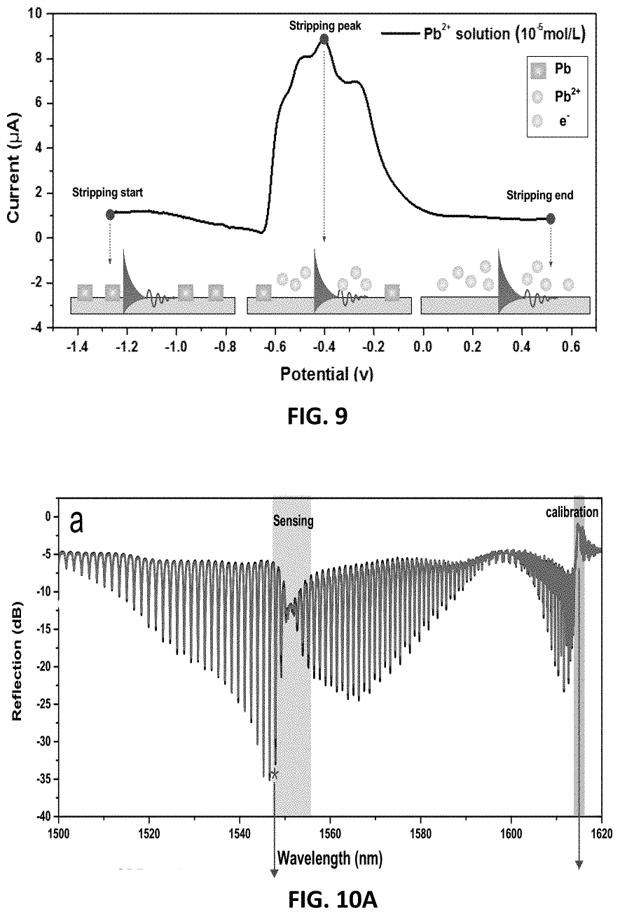

FIG. 9 shows the electrochemical current response during the stripping process, the protrusion peak is the stripping maximum of Pb²⁺ ions. The three points marked on this curve represent three stages of the stripping process; stage I (−1.30 V, the starting potential of the stripping process), stage II (−0.40 V, the stripping maximum of lead ions), stage III (0.50 V, the termination potential of the stripping process). These three representative points are considered as the electron polarization state of the metal film at these three potentials (Lee S et al., 2016).

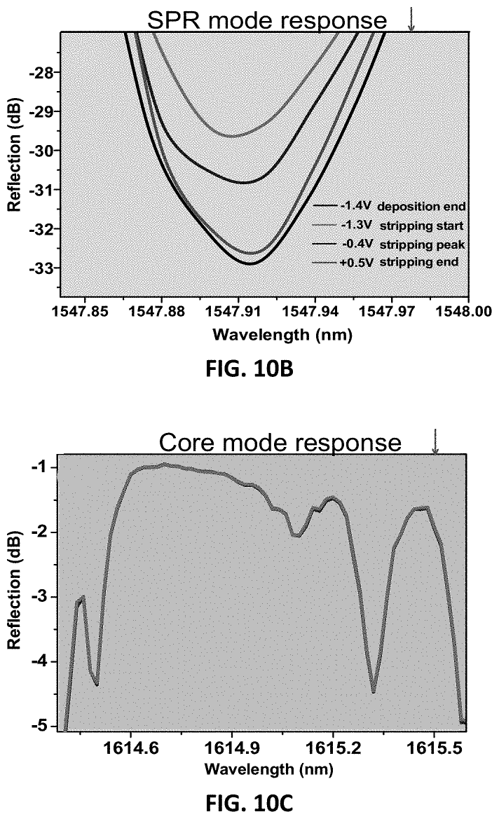

During the above-mentioned stripping process, the reflection spectrum from the optical fiber sensor was continuously recorded. In FIG. 10A shows the reflection spectra of the sensor during different stages. The light gray shaded region near 1550 nm, where the cladding modes of the fiber are attenuated by the surface plasmon resonance, is the part of the spectrum that is most affected by small changes in the refractive index of the medium surrounding the sensor. Within this region, the resonance at 1548.5 nm (marked it with an asterisk) was selected because it is clearly attenuated by transfer of energy to the surface plasmon but it still remains well-defined (with a high Q-factor value and signal-to-noise ratio) (Homola J et al., 1999). Detailed spectral responses centered on the selected spectral feature are shown in FIG. 10B: The black curve (−1.40 V) is the spectral feature observed during deposition; the pink curve (−1.30 V) is observed immediately after deposition; the blue curve (−0.40 V) is observed at the peak of stripping process of lead ions; the red curve (0.50 V) is observed at the end of the stripping process. As the sensor surface is subjected to deposition or stripping of metallic lead from the Pb²⁺ ions in solution, the selected resonance becomes shallower or deeper, respectively (Aragay G et al., 2012). Simultaneously, the Bragg core resonance near 1615 nm was observed, as shown in the darker gray shaded region in FIG. 10A, and in detail in FIG. 10C. Since this spectral feature remains completely unchanged during the whole reaction process, it was confirmed that it is immune to surrounding refractive index changes (the core mode does not “see” the refractive index at the cladding-gold film-surrounding liquid interface). This Bragg resonance wavelength is, however, sensitive to temperature, so that its unchanging wavelength indicates that the temperature remained constant during the whole sensing process. The reflected optical intensity at the Bragg wavelength also provides a means of detecting, and thereby correcting for, any changes in the optical power of the illumination source or transmission losses in the optical system.

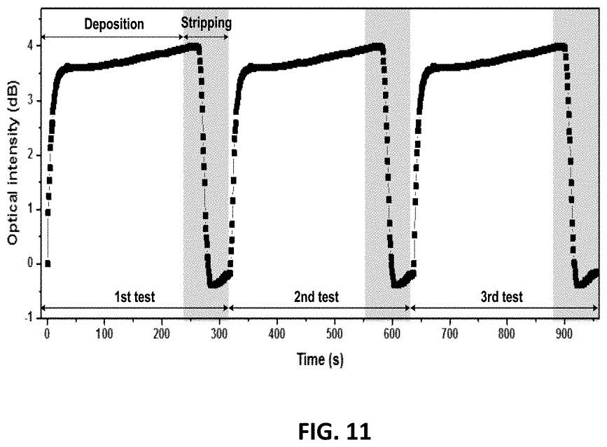

FIG. 11 shows the SPR spectral response of the DPASV continuously measured over three measurement cycles. It was observed that the optical fiber sensor rapidly rises to a balance value during the deposition process. Then, in the stripping process, it rapidly drops to the balance value close to the initial value near the peak of Pb²⁺ stripping (Li X et al., 2016). A stable and reproducible correlation between the real-time ions deposition-stripping cycles and the optical transmission of the optical fiber has been demonstrated.

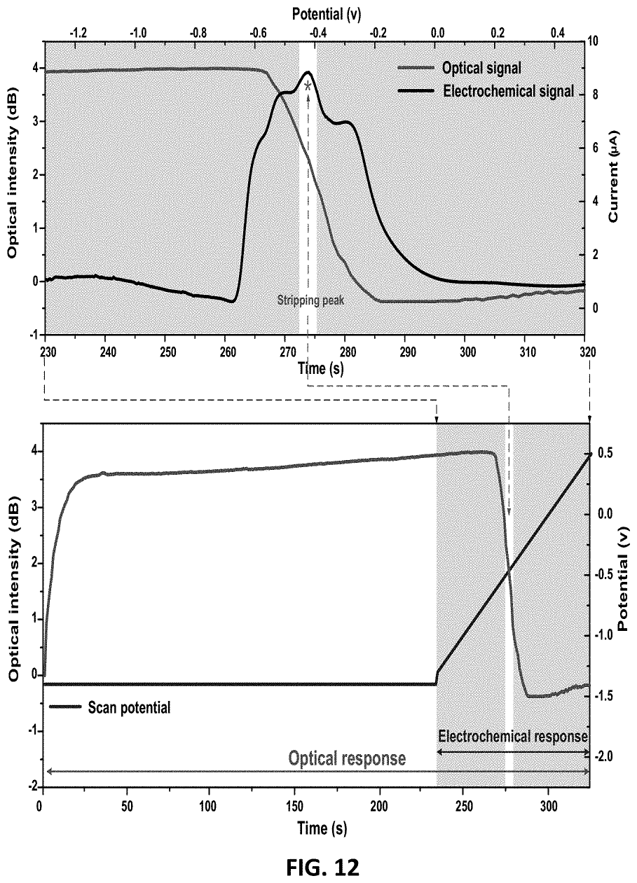

FIG. 12 shows a detailed comparison of optical SPR (red curve) and electrochemical DPASV results (black curve) during the stripping process. In FIG. 12, the lower panel shows the optical SPR response for the whole DPASV process of 320 s, with depositing process for 230 seconds and stripping process for 90 seconds. The SPR spectrum response is clearly related to the electrochemical stripping process. In the upper panel, the highest peak of the black line, marked by the arrow, is the stripping peak of Pb²⁺, which corresponds to the fastest change of the red line (SPR amplitude change). Therefore, the stripping peak voltage of the detected the analyte (Pb²⁺ ions) was clearly identified by taking the derivative of the SPR amplitude change. This shows the potential of the SPR optical method to realize specific ions detection.

The response sensitivity of the EC-SPR optical fiber sensor proposed herein was studied by carrying out two sets of measurements for different concentration of Pb²⁺ solutions. The first set of tests was for the Pb²⁺ concentration range from 10⁻⁵ to 10⁻⁴ M (small dynamic range, high Pb²⁺ concentration) and the second set of tests covered the Pb²⁺ concentration range from 10⁻¹⁰ to 10⁻⁵ M (large dynamic range, low concentration).

TABLE 1
Summary of the current methods and characteristics of heavy metal Pb²⁺ ions sensors

| Method | LOD | Detection range | Reference |
|---|---|---|---|
| Chromatography | 2.4 × 10⁻⁷ M | 9.7 × 10⁻⁷~9.7 × 10⁻⁵ M | Yi R et al., 2018 |
| Spectroscopy | 9.4 × 10⁻⁷ M | 10⁻⁶~5.0 × 10⁻⁴ M | Gao P F et al., 2018 |
| Gold nanostar electrode | 2.1 × 10⁻⁸ M | 6.3 × 10⁻⁸~1.6 × 10⁻⁶ M | Dutta S et al., 2019 |
| Nanoporous bismuth electrode | 7.2 × 10⁻⁹ M | 2.4 × 10⁻⁸~1.9 × 10⁻⁷ M | Hwang J H et al., 2019 |
| Engineered multi-walled carbon | 1.4 × 10⁻⁹ M | 9.7 × 10⁻⁹~2.4 × 10⁻⁶ M | Li X et al., 2016 |
| nanotubes material electrode | | | |
| Biopolymer-coated planar | 4.8 × 10⁻⁹ M | 2.4 × 10⁻⁹~4.8 × 10⁻⁸ M | Hwang J H et al., 2018 |
| carbon electrode | | | |
| Plasmonic fiber-optic sensor | 10⁻¹⁰ M | 10⁻¹⁰~10⁻⁵ M | This work |
| (SPR-TFBG) | | | |

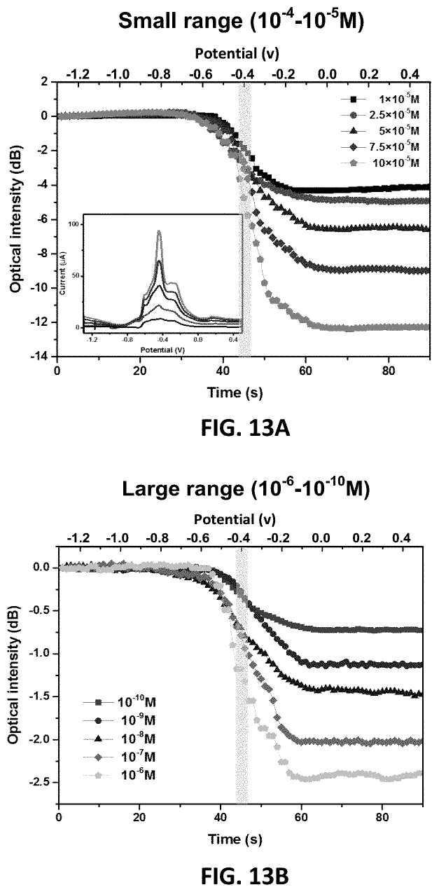

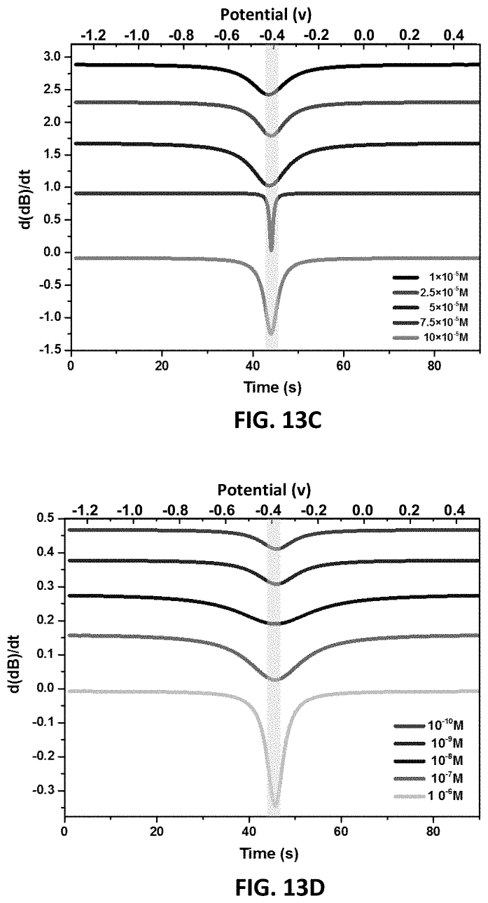

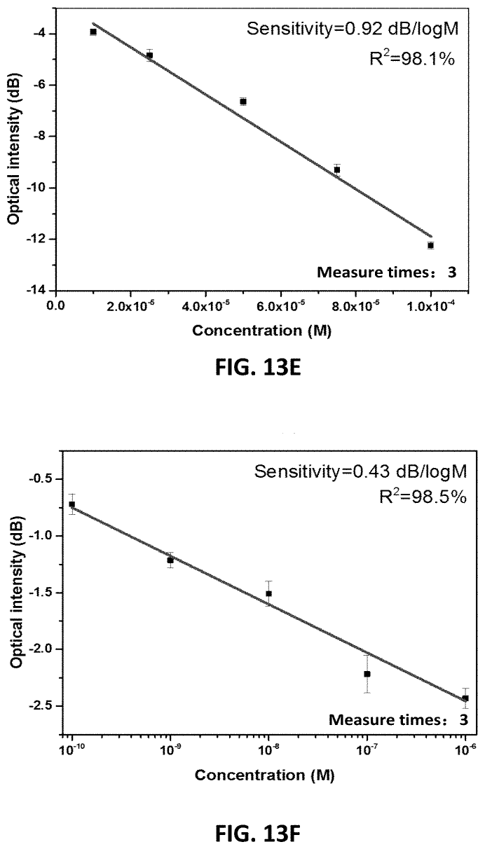

FIGS. 13A and 13B present the measured SPR sensor optical responses for the high and low Pb²⁺ concentrations, respectively. The inset in FIG. 13A shows the ASV current-voltage curves for the corresponding concentrations. It was observed that a good regularity of the SPR spectral response curves has been achieved, including the time to start stripping, the time to stabilize and the middle point with the highest rate (the stripping point of Pb²⁺). In order to identify that the above optical SPR changes are associated with the presence of Pb²⁺, the derivatives of the curves were plotted in FIG. 13C and FIG. 13D. It was found that the times of occurrence of the maximum derivative are well aligned (corresponding to the same stripping peak voltage around −0.40 V, as shown in the upper panel of FIG. 12) for each concentration. As the concentration of the solution becomes higher, the magnitude of the maximum derivatives also becomes greater, which is also in good agreement with the electrochemical ASV results. In order to clearly show the quantitative relationship between the SPR response and Pb²⁺ concentration, the maximum optical response was plotted and linearly fitted, as shown in FIGS. 13E and 13F. High linear responses (better than 98%) have been achieved for both small dynamic range (10⁻⁵˜10⁻⁴M) and large dynamic range (10⁻¹⁰˜10⁻⁵ M) of Pb²⁺ ions concentration. For repeated measurements, the sensor demonstrates a stable and reproducible response to Pb²⁺ ions concentration down to a LOD of 10⁻¹⁰ M. Table 1 summarizes the current methods and characteristics of heavy metal sensors reported so far for the detection Pb²⁺ ions. The sensor shows advantages compared to the reported alternative sensor schemes.

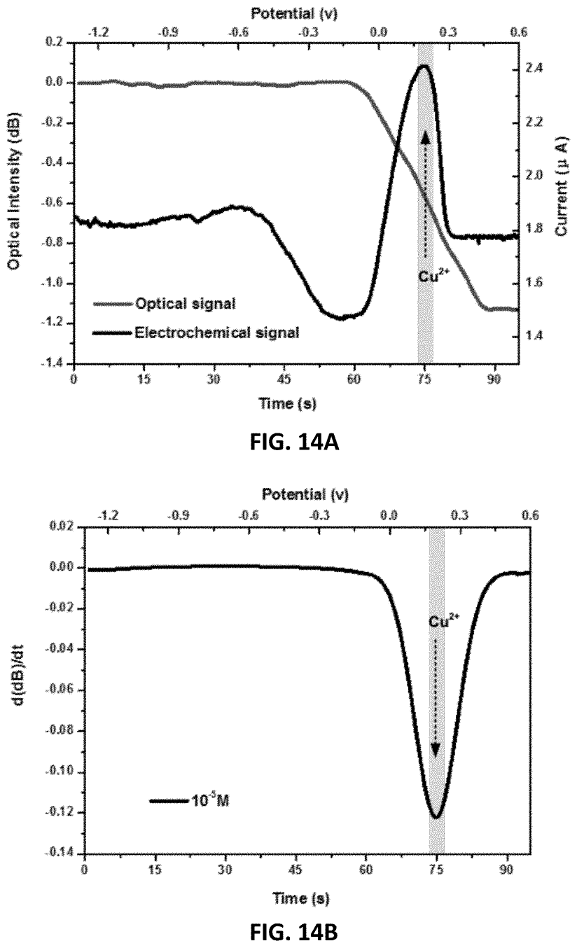

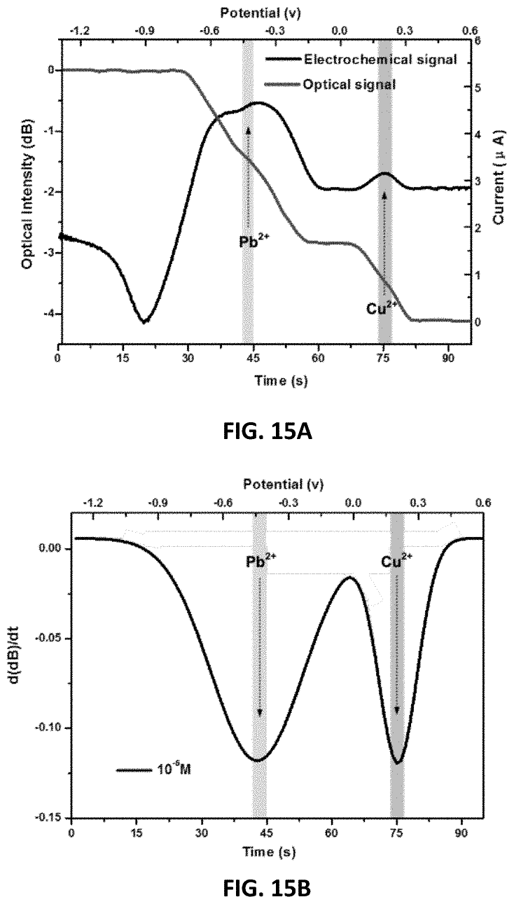

In order to demonstrate the selectivity of the sensor, control experiments were conducted by measuring a mixed solution of heavy metals Pb²⁺ and Cu²⁺ with the same concentration of 10⁻⁵ M. In the first step, samples were measured with only Cu²⁺ ions, as shown in FIGS. 14A and 14B. The highest peak of the black line is the stripping peak of Cu²⁺ at 0.20 V (marked by the arrow in FIG. 14A), which is corresponding to the highest slope of SPR amplitude change in the red line. So the stripping peak voltage of the detected the analyte (Cu²⁺) can be clearly identified by taking the derivative of the SPR amplitude change, as shown in FIG. 14B. In the second step, the mixed solution of heavy metals Pb²⁺ and Cu²⁺ ions were measured. The different stripping peaks of the two heavy metal ions can be clearly seen in the electrical signal, at −0.40 V (Pb²⁺) and 0.20 V (Cu²⁺) respectively. And most importantly, this two voltage values are also corresponding to the two fastest changes in the slope of SPR amplitude change in the red line, as marked by the two arrows in FIG. 15A. The stripping peak voltage of the detected analytical mixtures (Pb²⁺ and Cu²⁺) can be clearly identified by taking the derivative of the SPR amplitude change, as the two peaks shown in FIG. 15B. It demonstrates that the SPR fiber-optic sensor provides the ability of specific detection for different heavy metal ions.

Conclusions: An electrochemical-surface plasmon resonance optical fiber sensor for real-time and high-sensitivity monitoring of heavy metal ions is proposed and experimentally demonstrated. The gold coated optical fiber acts both as a working electrode and highly sensitive SPR sensor. A LOD down to 10⁻¹⁰ M and a linear response over a large range of 10⁻¹⁰˜10⁻⁵ M have been achieved. Stable and reproducible correlation between the real-time ion deposition-stripping cycles and the optical transmission of the optical fiber sensor has been proved over repeated tests. This sensor also shows good selectivity potential ability for specific detection together with temperature self-calibration ability. The proposed EC-SPR fiber-optic sensor has the advantages of compact size, flexible shape and remote operation capability, thereby opening the way for other opportunities for electrochemical monitoring in various hard-to-reach spaces and remote environments.

### REFERENCES

P. F. Gao, X. W. Zhang, H. Z. Kuang, “Study On Simultaneous Determination of Ni, Pb and Cd by Ion Chromatography,” IOP Conference Series: Earth and Environmental Science, vol. 146, no. 1, pp. 012068, 2018.
R. Yi, X. Yang, R. Zhou, “Determination of trace available heavy metals in soil using laser-induced breakdown spectroscopy assisted with phase transformation method,” Analytical Chemistry, vol. 90, no. 11, pp. 7080-7085, 2018.
Y. Shao, J. Wang, H. Wu, “Graphene based electrochemical sensors and biosensors: a review,” Electroanalysis: An International Journal Devoted to Fundamental and Practical Aspects of Electroanalysis, vol. 22, no. 10, pp. 1027-1036, 2010.
T. Guo, F. Liu, B. O. Guan, “Tilted fiber grating mechanical and biochemical sensors,” Optics & Laser Technology, vol. 78, pp. 19-33, 2016.
H. Gomaa, M. A. Shenashen, H. Yamaguchi, “Highly-efficient removal of ASV, Pb2+, Fe3+, and Al3+ pollutants from water using hierarchical, microscopic TiO2 and TiOF2 adsorbents through batch and fixed-bed columnar techniques,” Journal of Cleaner Production, vol. 182, pp. 910-925, 2018.
H. Gomaa, M. A. Shenashen, H. Yamaguchi, “Highly-efficient removal of ASV, Pb2+, Fe3+, and Al3+ pollutants from water using hierarchical, microscopic TiO2 and TiOF2 adsorbents through batch and fixed-bed columnar techniques,” Journal of Cleaner Production, vol. 182, pp. 910-925, 2018.
S. Lee, J. Oh, D. Kim, “A sensitive electrochemical sensor using an iron oxide/graphene composite for the simultaneous detection of heavy metal ions,” Talanta, vol. 160, pp. 528-536, 2016.
J. Homola, S. S. Yee, G. Gauglitz, “Surface plasmon resonance sensors,” Sensors and Actuators B: Chemical, vol. 54, no. 1-2, pp. 3-15, 1999.
G. Aragay, A. Merkoci, “Nanomaterials application in electrochemical detection of heavy metals,” Electrochimica Acta, vol. 84, pp. 49-61, 2012.
X. Li, H. Zhou, C. Fu, “A novel design of engineered multi-walled carbon nanotubes material and its improved performance in simultaneous detection of Cd (II) and Pb (II) by square wave anodic stripping voltammetry,” Sensors and Actuators B: Chemical, vol. 236, pp. 144-152, 2016.
S. Dutta, G. Strack, P. Kurup, “Gold nanostar electrodes for heavy metal detection,” Sensors and Actuators B: Chemical, vol. 281, pp. 383-391, 2019.
J. H. Hwang, X. Wang, S. Jung, “Enhanced electrochemical detection of multi-heavy metal ions using a biopolymer-coated planar carbon electrode,” IEEE Sensors Applications Symposium, pp. 1-6, 2018

1. A sensing apparatus for selectively characterizing at least one metal ion in a solution, comprising a fiber-optic sensor and a controller, wherein:
the fiber-optic sensor comprises an optical fiber and a coating assembly over an outside of the optical fiber, wherein the coating assembly is electrically conductive and active to surface plasmon resonance (SPR), and the fiber-optic sensor is configured, when in contact with the solution, to generate surface plasmon waves at an interface between the coating assembly and the solution upon a compatible input light shedding into and propagating in the optical fiber;
the controller is electrically connected with the coating assembly of the fiber-optic sensor, and is configured to provide an adjustable potential thereto such that when the coating assembly of the fiber-optic sensor is in contact with the solution, redox reactions of each of the at least one metal ion occur on an outer surface of the coating assembly, resulting in a detectable change of the surface plasmon waves generated in the fiber-optic sensor, wherein the change of the surface plasmon waves contains information of the each of the at least one metal ion in the solution.

2. The sensing apparatus of claim 1, wherein the optical fiber comprises a core and a cladding surrounding the core, wherein the core is provided with a tilted grating having an inclination angle of more than approximately 2°.

3. (canceled)

4. The sensing apparatus of claim 2 or claim 3, wherein the fiber-optic sensor further comprises a mirror having a reflective surface facing to a light incident surface of the optical fiber, wherein the mirror is configured to reflect optical signals generated and transmitted in the optical fiber back towards the light incident surface of the optical fiber.

5. The sensing apparatus of claim 1, wherein the coating assembly comprises a base film layer, wherein the base film layer is both electrically conductive and active to surface plasmon resonance (SPR).

6. The sensing apparatus of claim 5, wherein the base film layer is a metal film layer comprising at least one of gold (Au), silver (Ag), platinum (Pt), copper (Cu) or aluminum (Al).

7-10. (canceled)

11. The sensing apparatus of claim 5, wherein the coating assembly further comprises a conductive protective film layer over an outer surface of the base film layer, configured to protect an integrity of the base film layer.

12-13. (canceled)

14. The sensing apparatus of claim 5, wherein the coating assembly further comprises a transition film layer sandwiched between the optical fiber and the base film layer, configured to improve adhesion of the base film layer to the optical fiber.

15. (canceled)

16. The sensing apparatus of claim 1, wherein an outer surface of the coating assembly is modified to have an increased specific surface area.

17-20. (canceled)

21. The sensing apparatus of claim 1, wherein the controller comprises an electrochemical station, and the fiber-optic sensor serves as a working electrode of the electrochemical station, wherein the electrochemical station further comprises a reference electrode and a counter electrode.

22. (canceled)

23. The sensing apparatus of claim 1, wherein the at least one metal ion comprises ions of one or more of lead (Pb), mercury (Hg), copper (Cu), zinc (Zn), cobalt (Co), ion (Fe), nickel (Ni), arsenic (Ar), or chromium (Cr).

24. (canceled)

25. A sensing system, comprising:
a sensing apparatus according to claim 1;
a light source apparatus, optically coupled to a first end of, and configured to provide the input light into, the optical fiber in the fiber-optic sensor of the sensing apparatus; and
a signal detection apparatus, optically coupled to the sensing apparatus and configured to receive signals of the surface plasmon waves therefrom so as to derive the information of the each of the at least one metal ion in the solution.

26-29. (canceled)

30. The sensing system of claim 25, wherein the signal detection apparatus is coupled to the first end of the optical fiber, wherein:
a second end of the optical fiber opposing to the first end is provided with a mirror having a reflective surface facing to, configured to reflect optical signals generated and transmitted in the optical fiber back towards the first end of the optical fiber; and
the sensing system further comprises an optical fiber circulator, wherein:
the optical fiber circulator is optically arranged between the light source apparatus and the sensing apparatus along an input optical pathway and between the sensing apparatus and the signal detection apparatus along an output optical pathway; and
the optical fiber circulator is configured to separate the input optical pathway and the output optical pathway to thereby allow the signal detection apparatus to obtain the signals of the surface plasmon waves from the sensing apparatus without being influenced by the input light.

31. (canceled)

32. The sensing system of claim 25, wherein the signal detection apparatus is further configured to receive signals of other optical waves transmitted in the core of the optical fiber in the fiber-optic sensor of the sensing apparatus for calibration over noise information in the information of the each of the at least one metal ion in the solution.

33. (canceled)

34. The sensing system of claim 25, wherein a measurement range for a concentration of each of the at least metal ion in the solution is from approximately 10⁻⁴ M to approximately 10⁻¹⁰ M.

35. The sensing system of claim 25, wherein a limit of detection (LOD) for a concentration of each of the at least metal ion in the solution is lower than 10⁻¹⁰ M.

36. A method for selectively characterizing at least one metal ion in a solution using a sensing apparatus according to claim 1, comprising:
arranging the coating assembly of the fiber-optic sensor to be in contact with the solution;
providing the input light into the fiber-optic sensor of the sensing apparatus;
recording an amplitude of the surface plasmon waves transmitted from the fiber-optic sensor when providing, by means of the controller, a first potential to the fiber-optic sensor to allow each of the at least one metal ion to be reduced into a solid metal element corresponding thereto onto the outer surface of the coating assembly, until the amplitude increases to a first plateau;
recording an over-time change of the amplitude of the surface plasmon waves comprising a first sequence of sequentially decreasing plateaus when providing, by means of the controller, a second potential changing over time in a direction reverse to the first potential to the fiber-optic sensor to allow the solid metal element corresponding to each of the at least one metal ion to be oxidized to thereby strip from the coating assembly into the solution, until the amplitude decreases to a last of the first sequence of plateaus; and
analyzing the over-time change of the amplitude of the surface plasmon waves between the first plateau and the last of the first sequence of plateaus to thereby characterize the at least one metal ion in the solution.

37-38. (canceled)

39. The method of claim 36, wherein the analyzing the over-time change of the amplitude of the surface plasmon waves between the first plateau and the last of the first sequence of plateaus to thereby characterize the at least one metal ion in the solution comprises:
taking a derivative calculation at each point of a curve corresponding to the over-time change of the amplitude of the surface plasmon waves between the first plateau and the last of the first sequence of plateaus to thereby obtain a derivative-over-time curve; and
determining an identity of each of the at least one metal ion by identifying a characteristic trough on the derivative-over-time curve, wherein the trough corresponds to a locally fastest amplitude change thereon.

40. The method of claim 36, wherein the analyzing the over-time change of the amplitude of the surface plasmon waves between the first plateau and the last of the first sequence of plateaus to thereby characterize the at least one metal ion in the solution comprises:
calculating an amplitude change of the surface plasmon waves between each pair of two neighboring plateaus in a second sequence of plateaus sequentially comprising the first plateau and the first sequence of plateaus; and
determining a concentration of each of the at least one metal ion in the solution by plotting the calculated amplitude change corresponding to each pair of two neighboring plateaus in the second sequence of plateaus against a pre-determined standard curve, wherein the pre-determined standard curve is obtained in advance by plotting a set of sample solutions, each with a known yet different concentration of the each of the at least one metal ion.

41. The method of claim 40, wherein the standard curve is a linear curve, obtained by plotting an amplitude change of the surface plasmon waves relative to Log M for each sample solution, where M is a concentration of the each of the at least one metal ion in the each sample solution.

42. The method of claim 36, further comprising, prior to the analyzing the over-time change of the amplitude of the surface plasmon waves between the first plateau and the last of the first sequence of plateaus to thereby characterize the at least one metal ion in the solution:
recording signals of other optical waves transmitted in the core of the optical fiber in the fiber-optic sensor;
wherein the analyzing the over-time change of the amplitude of the surface plasmon waves between the first plateau and the last of the first sequence of plateaus to thereby characterize the at least one metal ion in the solution comprises:
performing a calibration to the over-time change of the amplitude of the surface plasmon waves; and
analyzing the calibrated over-time change of the amplitude of the surface plasmon waves between the first plateau and the last of the first sequence of plateaus to characterize the at least one metal ion in the solution.
